(19) United States
(12) Patent Application Publication
(10) Pub. No.: US 2025/0156364 A1
(43) Pub. Date: May 15, 2025

(54) SERVER, SERVER ASSET INFORMATION ACQUISITION METHOD AND APPARATUS, AND SERVER ASSET INFORMATION PROVIDING METHOD AND APPARATUS

(71) Applicant: SUZHOU METABRAIN INTELLIGENT TECHNOLOGY CO.,LTD., Suzhou (CN)

(72) Inventor: Xingping QIU, Suzhou (CN)

(73) Assignee: SUZHOU METABRAIN INTELLIGENT TECHNOLOGY CO.,LTD., Suzhou (CN)

(21) Appl. No.: 19/019,448

(22) Filed: Jan. 13, 2025

Related U.S. Application Data
(63) Continuation of application No. PCT/CN2023/132737, filed on Nov. 20, 2023.

(30) Foreign Application Priority Data
Dec. 6, 2022 (CN) 202211554107.1

(51) Int. Cl. G06F 13/42

(52) U.S. Cl. CPC G06F 13/4221; G06F 2213/0026

(57) ABSTRACT

The present application relates to the technical field of servers, and discloses a server asset information acquisition method and apparatus, a server asset information providing method and apparatus, a baseboard management controller (BMC), and a server. The acquisition method comprises: in the process of starting a basic input output system (BIOS), sending a peripheral component interconnect express (PCIe) physical topology acquisition request to a BMC; acquiring PCIe physical topology data corresponding to the PCIe topology acquisition request returned by the BMC; and acquiring a PCIe system topology of a server according to the PCIe physical topology data and PCIe device logic information.

### CROSS-REFERENCE TO RELATED APPLICATION

The present application is a filing under 35 U.S.C. § 111 of international application number PCT/CN2023/132737, filed Nov. 20, 2023, which claims priority to Chinese Patent Application No. 202211554107.1, filed with the China National Intellectual Property Administration on Dec. 6, 2022, and entitled “SERVER, SERVER ASSET INFORMATION ACQUISITION METHOD AND APPARATUS, AND SERVER ASSET INFORMATION PROVIDING METHOD AND APPARATUS”, which is incorporated herein by reference in its entirety.

### TECHNICAL FIELD

The present disclosure relates to the technical field of servers, and in particular, to a server asset information acquisition method and apparatus, a server asset information providing method and apparatus, a baseboard management controller, and a server.

### BACKGROUND

With the increasingly rich server configurations, such as the growing number and variety of Peripheral Component Interconnect Express (PCIe, which is a high-speed serial computer expansion bus standard) devices equipped in a server, it is difficult for the server to conveniently acquire its own asset information.

Therefore, how to conveniently acquire the asset information of the server to display the server configurations is an urgent problem that needs to be resolved.

### SUMMARY

Embodiments of the present disclosure provide a server asset information acquisition method and apparatus, a server asset information providing method and apparatus, a baseboard management controller, and a server, which may conveniently acquire PCIe device asset information of a server and display server configurations.

To solve the above technical problem, the embodiments of the present disclosure provide a server asset information acquisition method, including:
sending a high-speed serial computer expansion bus standard (PCIe) physical topology acquisition request to a baseboard management controller in a startup process of a basic input output system;
acquiring PCIe physical topology data corresponding to the PCIe topology acquisition request and returned by the baseboard management controller, wherein the PCIe physical topology data is stored in a preset memory accessible by the baseboard management controller; and
acquiring a PCIe system topology of a server according to the PCIe physical topology data and PCIe device logical information.

In some exemplary embodiments, the PCIe physical topology data includes at least one of PCIe root port information, PCIe bandwidth information, a PCIe device type, and a PCIe device number; and the PCIe device logical information includes at least one of a device type, a root port, and bus device function information corresponding to each PCI device.

In some exemplary embodiments, the acquiring PCIe physical topology data corresponding to the PCIe topology acquisition request and returned by the baseboard management controller includes:
acquiring target PCIe physical topology data corresponding to the PCIe topology acquisition request and returned by the baseboard management controller, wherein the target PCIe physical topology data is PCIe physical topology data corresponding to a target package, the target package is any one of one or more preset packages, and the preset memory stores PCIe physical topology data corresponding to each of the one or more preset packages.

In some exemplary embodiments, before the sending a PCIe topology acquisition request to a baseboard management controller, the server asset information acquisition method further includes:
acquiring header information corresponding to the target PCIe physical topology data from the baseboard management controller;
detecting whether the target PCIe physical topology data to be acquired is correct according to a preset package identifier and a package identifier in the header information; and
when the target PCIe physical topology data to be acquired is correct, generating the PCIe topology acquisition request according to data length information in the header information, and sending the PCIe topology acquisition request to the baseboard management controller.

In some exemplary embodiments, after the acquiring a PCIe system topology of a server according to the PCIe physical topology data and PCIe device logical information, the server asset information acquisition method further includes:
sending the PCIe device logical information to the baseboard management controller, to enable the baseboard management controller to obtain the PCIe system topology of the server according to the PCIe physical topology data and the PCIe device logical information.

In some exemplary embodiments, the server asset information acquisition method further includes:
controlling, according to an acquired PCIe physical topology adjustment instruction, the baseboard management controller to update the PCIe physical topology data stored in the preset memory.

In some exemplary embodiments, the PCIe physical topology data includes the PCIe root port information, and the PCIe root port information includes x2 port indexes corresponding to respective PCIe root ports of a Central Processing Unit (CPU).

In some exemplary embodiments, the PCIe physical topology data includes a PCIe device type and a PCIe device number; the PCIe device type includes: an “O” identifier corresponding to an open compute project card type, an “N” identifier corresponding to a non-volatile memory host controller interface specification device type, a “G” identifier corresponding to a graphics processing unit type, a “T” identifier corresponding to an adapter expansion card type, and/or a “P” identifier corresponding to other PCIe device types; and the PCIe device number includes: 0 corresponding to the open compute project card type, a decimal label number corresponding to the non-volatile memory host controller interface specification device type, a decimal label number corresponding to the graphics processing unit type, a decimal label number corresponding to the adapter expansion card type, and/or a decimal label number corresponding to other PCIe device types.

In some exemplary embodiments, after the acquiring PCIe physical topology data corresponding to the PCIe topology acquisition request and returned by the baseboard management controller, the server asset information acquisition method further includes:
determining whether the PCIe physical topology data is the same as backup PCIe physical topology data in a backup memory;
when the PCIe physical topology data is the same as the backup PCIe physical topology data in the backup memory, acquiring the PCIe system topology of the server according to the PCIe physical topology data and the PCIe device logical information; and
when the PCIe physical topology data is different from the backup PCIe physical topology data in the backup memory, updating the backup PCIe physical topology data using the PCIe physical topology data, and acquiring the PCIe system topology of the server according to the PCIe physical topology data and the PCIe device logical information.

In some exemplary embodiments, before the determining whether the PCIe physical topology data is the same as backup PCIe physical topology data in a backup memory, the server asset information acquisition method further includes:
performing a cyclic redundancy check on the PCIe physical topology data to detect whether the acquired PCIe physical topology data is correct;
when the acquired target PCIe physical topology data is correct, determining whether the PCIe physical topology data is the same as the backup PCIe physical topology data in the backup memory; and
when the acquired target PCIe physical topology data is incorrect, acquiring the PCIe system topology of the server according to the backup PCIe physical topology data and the PCIe device logical information.

The embodiments of the present disclosure further provide a server asset information acquisition apparatus, including:
a physical topology request module, configured to send a high-speed serial computer expansion bus standard (PCIe) physical topology acquisition request to a baseboard management controller in a startup process;
a physical topology acquisition module, configured to acquire PCIe physical topology data corresponding to the PCIe topology acquisition request and returned by the baseboard management controller, wherein the PCIe physical topology data is stored in a preset memory accessible by the baseboard management controller; and
an asset acquisition module, configured to acquire a PCIe system topology of a server according to the PCIe physical topology data and PCIe device logical information.

The embodiments of the present disclosure further provide a server, including:
a memory, configured to store a computer program; and
a processor, configured to implement, when executing the computer program, the operations of the above server asset information acquisition method.

The embodiments of the present disclosure further provide a server asset information providing method, including:
acquiring, by a baseboard management controller, a high-speed serial computer expansion bus standard (PCIe) physical topology acquisition request of a server;
acquiring PCIe physical topology data from a preset memory according to the PCIe physical topology acquisition request; and
sending the PCIe physical topology data to the server to enable the server to acquire a PCIe system topology of the server according to the PCIe physical topology data and PCIe device logical information.

In some exemplary embodiments, after the sending the PCIe physical topology data to the server, the server asset information providing method further includes:
receiving the PCIe device logical information sent by the server; and
acquiring the PCIe system topology of the server according to the PCIe physical topology data and the PCIe device logical information.

In some exemplary embodiments, after the acquiring the PCIe system topology of the server according to the PCIe physical topology data and the PCIe device logical information, the server asset information providing method further includes:
sending the PCIe system topology to a web (World Wide Web) page for display.

In some exemplary embodiments, after the acquiring the PCIe system topology of the server according to the PCIe physical topology data and the PCIe device logical information, the server asset information providing method further includes:
detecting whether there is a missing PCIe device in the server according to the PCIe system topology and the PCIe physical topology data; and
when there is the missing PCIe device in the server, displaying a PCIe device type and/or a PCIe device number corresponding to the missing PCIe device in the PCIe physical topology data.

In some exemplary embodiments, the server asset information providing method further includes:
updating the PCIe physical topology data stored in the preset memory according to a PCIe physical topology modification instruction sent by the server or a remote terminal.

The embodiments of the present disclosure further provide a server asset information providing apparatus, applied to a baseboard management controller, and including:
a request acquisition module, configured to acquire a high-speed serial computer expansion bus standard (PCIe) physical topology acquisition request of a server;
a data acquisition module, configured to acquire PCIe physical topology data from a preset memory according to the PCIe physical topology acquisition request; and
a data sending module, configured to send the PCIe physical topology data to the server to enable the server to acquire a PCIe system topology of the server according to the PCIe physical topology data and PCIe device logic information.

The embodiments of the present disclosure further provide a baseboard management controller, including:
a memory, configured to store a computer program; and
a processor, configured to implement, when executing the computer program, the operations of the above server asset information providing method.

The embodiments of the present disclosure further provide a computer non-volatile readable storage medium. The computer non-volatile readable storage medium stores a computer program, and the computer program, when executed by a processor, implements the operations of the above server asset information acquisition method or the operations of the above server asset information providing method.

The server asset information acquisition method provided in the embodiments of the present disclosure includes: sending the PCIe physical topology acquisition request to the baseboard management controller in the startup process of the basic input output system; acquiring the PCIe physical topology data corresponding to the PCIe topology acquisition request and returned by the baseboard management controller, where the PCIe physical topology data is stored in the preset memory accessible by the baseboard management controller; and acquiring the PCIe system topology of the server according to the PCIe physical topology data and the PCIe device logical information.

Evidently, in the embodiments of the present disclosure, by storing the PCIe physical topology data in the preset memory accessible by the Baseboard Management Controller (BMC) of the server, the PCIe physical topology data may be conveniently acquired from the BMC in the startup process of the Basic Input Output System (BIOS), thereby utilizing the PCIe physical topology data and the PCIe device logical information to obtain the PCIe system topology of the server. The PCIe device asset information of the server may be conveniently acquired, thereby facilitating display of the server configurations. Additionally, the embodiments of the present disclosure further provide a server asset information acquisition apparatus, a basic input output system, a baseboard management controller, and a server, which also have the above beneficial effects.

### BRIEF DESCRIPTION OF THE DRAWINGS

In order to describe technical solutions in embodiments of the present disclosure or in the related art more clearly, accompanying drawings required to be used in descriptions of the embodiments or the related art will be briefly introduced below, it is apparent that the accompanying drawings described below are only some embodiments of the present disclosure, and those having ordinary skill in the art may also obtain other accompanying drawings according to these accompanying drawings without creative work.

FIG. 1 is a flowchart of a server asset information acquisition method according to an embodiment of the present disclosure;

FIG. 2 is a schematic diagram of an exemplary implementation of another server asset information acquisition method according to an embodiment of the present disclosure;

FIG. 3 is a diagram of displaying x2 port indexes of another server asset information acquisition method according to an embodiment of the present disclosure;

FIG. 4 is a flowchart of another server asset information acquisition method according to an embodiment of the present disclosure;

FIG. 5 is a block diagram of a structure of a server asset information acquisition apparatus according to an embodiment of the present disclosure;

FIG. 6 is a schematic diagram of a structure of a server according to an embodiment of the present disclosure;

FIG. 7 is a schematic diagram of an exemplary structure of a server according to an embodiment of the present disclosure;

FIG. 8 is a flowchart of a server asset information providing method according to an embodiment of the present disclosure;

FIG. 9 is a block diagram of a structure of a server asset information providing apparatus according to an embodiment of the present disclosure;

FIG. 10 is a schematic diagram of a structure of a baseboard management controller according to an embodiment of the present disclosure; and

FIG. 11 is a schematic diagram of a structure for implementing the server asset information acquisition method according to the embodiments of the present disclosure.

### DETAILED DESCRIPTION OF THE EMBODIMENTS

To make the objectives, technical solutions, and advantages of embodiments of the present disclosure more clear, the technical solutions in the embodiments of the present disclosure are clearly and completely described in combination with accompany drawings in the embodiments of the present disclosure as below, and it is apparent that the described embodiments are a part rather all of the embodiments of the present disclosure. All other embodiments obtained by those having ordinary skill in the art based on the embodiments of the present disclosure without creative efforts shall fall within the scope of protection of the present disclosure.

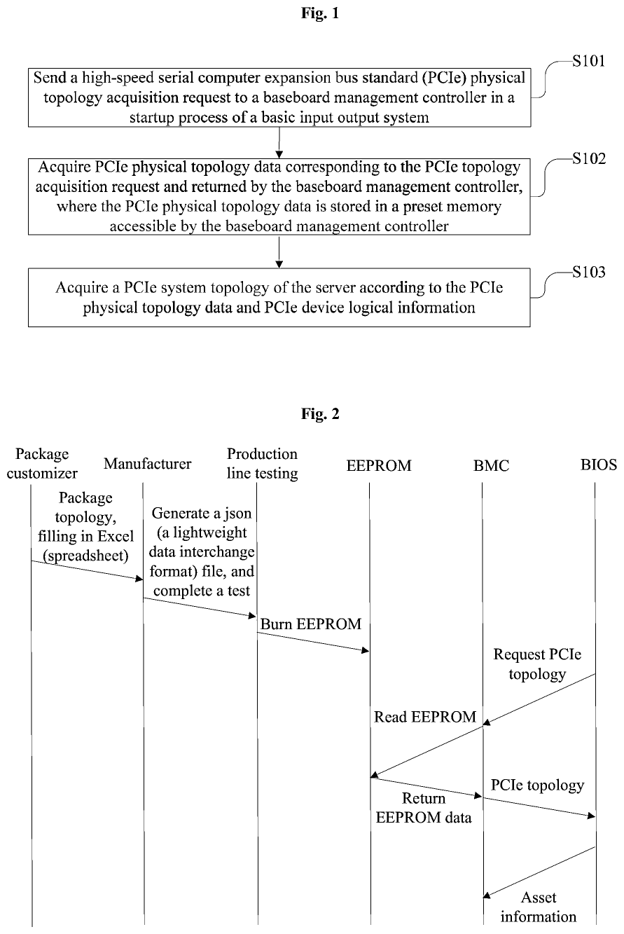

Referring to FIG. 1, FIG. 1 is a flowchart of an asset information acquisition method according to an embodiment of the present disclosure. The asset information acquisition method may include the following operations 101 to 103.

In operation 101, a PCIe physical topology acquisition request is sent to a baseboard management controller in a startup process of a basic input output system.

It should be understood that in this embodiment, a processor of a server in this embodiment may send the PCIe physical topology acquisition request (e.g., a PCIe topology request in FIG. 2) to the Baseboard Management Controller (BMC) in the startup process of the Basic Input Output System (BIOS), thereby requesting to obtain, through the BMC, the PCIe physical topology data stored in the preset memory accessible by the BMC.

In this embodiment, the specific time when the server acquires the PCIe physical topology data from the BMC may be set by a designer. For example, in this operation, the server may send the PCIe physical topology acquisition request to the BMC in a Power On Self Test (POST) process of the BIOS startup. For example, the processor of the server may send the PCIe physical topology acquisition request to the BMC through an Intelligent Platform Management Interface (ipmi) in the POST process of the BIOS startup, thereby acquiring the PCIe physical topology data from the BMC through the ipmi. The server may also send the PCIe physical topology acquisition request to the BMC in other processes of the BIOS startup. This embodiment does not impose any limitation on the specific time when the server acquires the PCIe physical topology data from the BMC, as long as the server may acquire the PCIe physical topology data from the BMC in the startup process of the BIOS to obtain the PCIe system topology of the server.

In some exemplary embodiments, the PCIe physical topology acquisition request in this operation may be a request to acquire PCIe physical topology data for a required preset package (i.e., a server configuration package) stored in the preset memory. For example, when the preset memory only stores PCIe physical topology data for one preset package, the PCIe physical topology acquisition request may request to acquire the PCIe physical topology data for the preset package; and when the preset memory stores PCIe physical topology data for a plurality of preset packages, the PCIe physical topology acquisition request may request to acquire PCIe physical topology data for a target package, where the target package is any one of the plurality of preset packages stored in the preset memory.

Correspondingly, before this operation, the server may first acquire header information corresponding to target PCIe physical topology data from the BMC. According to a preset package identifier and a package identifier in the header information, whether target PCIe physical topology data to be acquired is correct is detected, that is, whether the PCIe physical topology data is a PCIe topology supported by the server. When the PCIe physical topology data is the PCIe topology supported by the server, a PCIe topology acquisition request is generated according to data length information in the header information and operation 101 is performed to obtain the target PCIe physical topology data from the BMC, wherein the target PCIe physical topology data may be the PCIe physical topology data for the target package. In other words, in the startup process of the BIOS, the server may determine whether the target PCIe physical topology data to be acquired is correct by comparing the package identifier (i.e., a target package identifier) in the header information corresponding to the target PCIe physical topology data to be acquired with the preset package identifier, namely whether the target PCIe physical topology data to be acquired is the PCIe topology supported by the server.

Correspondingly, the preset package identifier may be a pre-configured package identifier of PCIe physical topology data required by the server, for example, the preset package identifier may be stored in the BMC or the server. For example, the server may acquire the header information corresponding to the target PCIe physical topology data and the preset package identifier from the BMC. The server may alternatively detect whether the target PCIe physical topology data to be acquired is correct using the preset package identifier stored in the server and the package identifier in the header information acquired from the BMC. This embodiment does not impose any limitation on the storage position of the preset package identifier.

In operation 102, PCIe physical topology data corresponding to the PCIe topology acquisition request and returned by the baseboard management controller is acquired, wherein the PCIe physical topology data is stored in a preset memory accessible by the baseboard management controller.

It should be understood that in this operation, the processor of the server may obtain the PCIe physical topology data (e.g., a PCIe topology in FIG. 2) from the BMC in the startup process of the BIOS. A specific method for the processor to acquire the PCIe physical topology data corresponding to the PCIe topology acquisition request and returned by the baseboard management controller in this operation may be set by the designer. For example, when the preset memory only stores PCIe physical topology data for one preset package, the server may acquire the PCIe physical topology data returned by the BMC in this operation; and when the preset memory stores PCIe physical topology data for a plurality of preset packages, in this operation, the server may acquire target PCIe physical topology data corresponding to the PCIe topology acquisition request and returned by the baseboard management controller, wherein the target PCIe physical topology data is PCIe physical topology data corresponding to a target package, the target package is any one of the plurality of preset packages, and the preset memory stores PCIe physical topology data corresponding to each of the plurality of preset packages. This embodiment does not impose any limitation on this.

Correspondingly, before this operation, the BMC may acquire the PCIe physical topology data from the preset memory according to the PCIe physical topology acquisition request and send the PCIe physical topology data to the processor running the BIOS in the server. For example, when the preset memory stores PCIe physical topology data for a plurality of preset packages, the BMC may acquire target PCIe physical topology data corresponding to a preset package identifier from the preset memory according to the PCIe physical topology acquisition request, that is, the target package may be a preset package corresponding to the preset package identifier.

In some exemplary embodiments, the preset package identifier may be stored in the BMC. That is, the BMC may use the preset package identifier stored in the BMC to acquire the target PCIe physical topology data from the preset memory according to the PCIe physical topology acquisition request. The preset package identifier may also be stored in the server. That is, the BMC may use the preset package identifier received in the startup process of the BIOS to acquire the target PCIe physical topology data from the preset memory according to the PCIe physical topology acquisition request.

It should be noted that the preset memory in this embodiment may be a pre-configured memory that stores PCIe physical topology data corresponding to one or more preset packages. The specific memory type of the preset memory may be set by the designer according to practical scenarios and user requirements. For example, the preset memory may be a memory from/on which the BMC is able to read and modify data, such as an Electrically Erasable Programmable Read Only Memory (EEPROM) shown in FIG. 2, thereby allowing the BMC to modify and update the PCIe physical topology data stored in the preset memory. The preset memory may also be a memory from which the BMC is only able to read data. This embodiment does not impose any limitation on this.

In some exemplary embodiments, the PCIe physical topology data stored in the preset memory in this embodiment may be hardware physical information (i.e., a hardware topology) in a PCIe system corresponding to a preset server configuration package (i.e., a preset package), such as a PCIe root port (of a CPU) and physical information of various PCIe devices. The specific content of the PCIe physical topology data in this embodiment may be set by the designer according to practical scenarios and user requirements. For example, the PCIe physical topology data may include at least one of PCIe root port information, PCIe bandwidth information, a PCIe device type, and a PCIe device number. For example, the PCIe physical topology data may include information about a configured PCIe root port (i.e., PCIe root port information), a device type (i.e., a PCIe device type) and a device number (a PCIe device number) of a configured PCIE device. The PCIe physical topology data may also include information about a configured PCIe bandwidth (i.e., PCIe bandwidth information). This embodiment does not impose any limitation on the specific content of the PCIe physical topology data.

As shown in FIG. 2, a creator of the server configuration package may transmit the hardware topology of the configured PCIe system to a manufacturer team in the form of an Excel spreadsheet. The manufacturer team may generate a corresponding configuration file, such as a Javascript Object Notation (json, a lightweight data interchange format) file, according to the hardware topology configuration. After the configuration file is tested, a production line may burn/send the configuration file storing the PCIe physical topology data to the EEPROM accessible by the BMC. For example, the production line Diag (a testing tool) invokes a BMC interface to send the configuration file to the EEPROM through the BMC.

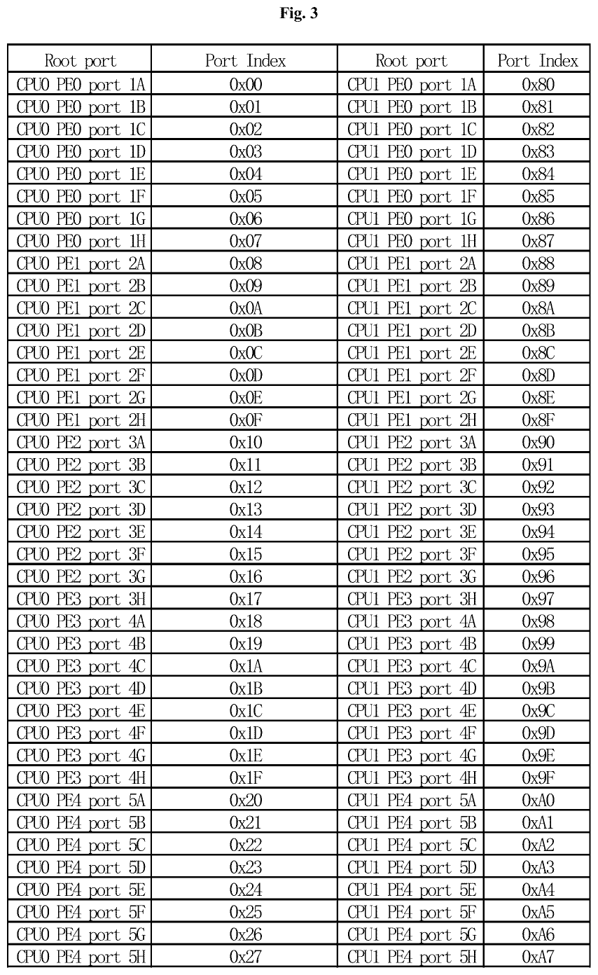

In some exemplary embodiments, a data format definition of the configuration file may be a data format definition supported by the EEPROM, such as “configuration file data definition V0.2”. For example, in a configuration file adopting “configuration file data definition V0.2”, the PCIe root port information in the PCIe physical topology data may include x2 port indexes corresponding to PCIe root ports of the CPU. For example, an Elastic GPU Service (EGS) platform uses two Sapphire Rapids CPUs (an Intel CPU), each with 5×16 root ports for PCIe Gen5 (a type of PCIe interface). Each root port may be divided into various combination configurations such as x16, x8, x4, and x2. In this embodiment, the lowest x2 mode may be used, with numbering shown in FIG. 3 to be performed according to x2|x2|x2|x2|x2|x2|x2|x2 to obtain the x2 port indexes corresponding to the PCIe root ports of the CPU.

Correspondingly, in the configuration file adopting “configuration file data definition V0.2”, the PCIe bandwidth information in the PCIe physical topology data may be configured according to the definition in the following table, that is, the PCIe bandwidth information for x16 bandwidth may be identified as “0x10”.

TABLE 1
Correspondence Table of PCIe Bandwidth
and Configuration File Data

| | |
|---|---|
| X16 | 0x10 |
| X8 | 0x08 |
| X4 | 0x04 |
| X2 | 0x02 |

Correspondingly, in the configuration file adopting “configuration file data definition V0.2”, the PCIe device type and the PCIe device number in the PCIe physical topology data may include the following categories: an Open Compute Project (OCP) card type is abbreviated with the character “O”, and the PCIe device number is typically 0, indicating that only one OCP card is configured; a Non-Volatile Memory express (NVMe, a non-volatile memory host controller interface specification) device type may be abbreviated with the character “N,” with the PCIe device number using a decimal number the same as a number on a chassis silkscreen/panel label (i.e., a decimal label number); a Graphics Processing Unit (GPU) card type may be abbreviated with the character “G”, with the PCIe device number using a decimal number the same as the number on the chassis silkscreen/panel label (i.e., the decimal label number), that is, when the panel silkscreen indicates the GPU, the PCIe device number may use the decimal number the same as the number on the chassis silkscreen/panel label; and a Trimode (an adapter expansion card) card type may be abbreviated with the character “T”, with the PCIe device number using a decimal number the same as the number on the chassis silkscreen/panel label (i.e., the decimal label number), and may also indicate that there is subsequent expansion information; and other PCIe devices may be abbreviated with the character “P”, with the PCIe device number using a decimal number. In other words, when the PCIe physical topology data includes the PCIe device type and the PCIe device number, the PCIe device type may include: the “O” identifier corresponding to the open compute project card type, the “N” identifier corresponding to the non-volatile memory host controller interface specification device type, the “G” identifier corresponding to the graphics processing unit type, the “T” identifier corresponding to the adapter expansion card type, and/or the “P” identifier corresponding to other PCIe device types. The PCIe device number may include: 0 corresponding to the open compute project card type, a decimal label number corresponding to the non-volatile memory host controller interface specification device type, a decimal label number corresponding to the graphics processing unit type, a decimal label number corresponding to the adapter expansion card type, and/or a decimal label number corresponding to other PCIe device types.

In some exemplary embodiments, after this operation, the processor may check whether the acquired PCIe physical topology data is correct, thereby utilizing the correct PCIe physical topology data to obtain the PCIe system topology of the server. For example, the processor may perform a Cyclic Redundancy Check (CRC) on the PCIe physical topology data in the startup process of the BIOS to detect whether the acquired PCIe physical topology data is correct; when the acquired target PCIe physical topology data is correct, operation 103 is performed, or after backup PCIe physical topology data in a backup memory is updated, operation 103 is performed; and when the acquired target PCIe physical topology data is incorrect, the PCIe physical topology data is reacquired from the BMC, or the backup PCIe physical topology data in the backup memory and PCIe device logical information are utilized to acquire the PCIe system topology of the server.

Correspondingly, after this operation, the processor may determine whether the PCIe physical topology data is the same as the backup PCIe physical topology data in the backup memory; when the PCIe physical topology data is the same as the backup PCIe physical topology data in the backup memory, operation 103 is performed; when the PCIe physical topology data is different from the backup PCIe physical topology data in the backup memory, the backup PCIe physical topology data is updated using the PCIe physical topology data, and operation 103 is performed to ensure that the backup PCIe physical topology data stored in the backup memory may be the latest and correct PCIe physical topology data, thereby using the backup PCIe physical topology data and the PCIe device logical information to acquire the PCIe system topology of the server when the correct PCIe physical topology data cannot be acquired from the BMC.

In operation 103, the PCIe system topology of the server is acquired according to the PCIe physical topology data and the PCIe device logical information.

In some exemplary embodiments, the PCIe device logical information may be logical information of a PCIe device actually configured in the server within the PCIe system, that is detected and acquired by the processor of the server in the startup process of the BIOS. For example, the logical information may include information such as the device type, the root port, and Bus, Device, Function (BDF) information corresponding to each PCIe device.

Correspondingly, the specific content of the PCIe device logical information in this embodiment may be set by the designer according to practical scenarios and user requirements. For example, the PCIe device logical information may include at least one of the device type, the root port, and the BDF information corresponding to each PCIe device actually configured in the server. This embodiment does not impose any limitation on this as long as the processor may utilize the PCIe device logical information and the PCIe physical topology data to obtain the PCIe system topology of the server.

It should be understood that in this operation, the server may utilize the PCIe physical topology data acquired from the BMC and the detected PCIe device logical information in the startup process of the BIOS. By correlating device logical addresses with physical positions and other information through the respective root ports of the PCIe devices, the PCIe system topology of the server is obtained, and therefore actual PCIe device asset information is obtained.

Correspondingly, the server may acquire the PCIe system topology of the server according to the PCIe physical topology data and the PCIe device logical information in the POST process of the BIOS startup; and according to the obtained PCIe system topology, a system slot data table of a system management BIOS (SMBIOS, a unified specification for displaying product management information in a standard format) is filled, such as SMBIOS type 9, to facilitate subsequent display of the PCIe system topology on a server side. For example, the server may fill in SMBIOS type 9 according to the obtained PCIe system topology in the POST process of the BIOS startup, and the subsequent POST process continues to finish the BIOS startup.

In some exemplary embodiments, the processor may send the acquired PCIe device logical information to the BMC, such that the BMC may obtain the PCIe system topology of the server according to the PCIe physical topology data and the PCIe device logical information, thereby causing the BMC to utilize the PCIe system topology actually configured in the server for subsequent processing, such as web page display, heat dissipation strategy adjustment, and/or, PCIe physical topology data check. For example, after operation 103, the processor may send the acquired PCIe device logical information to the BMC.

In some exemplary embodiments, the asset information acquisition method provided in this embodiment may further include: the processor of the server controls, according to an acquired PCIe physical topology adjustment instruction, the baseboard management controller to update the PCIe physical topology data stored in the preset memory. In other words, the server may update and adjust, through the BMC, the PCIe physical topology data stored in the preset memory, so as to flexibly update a PCIe topology for a new PCIe device, and avoid a re-adaptation action of the PCIe devices due to the addition of the new PCIe device.

In this embodiment, according to this embodiment of the present disclosure, by storing the PCIe physical topology data in the preset memory accessible by the BMC of the server, the PCIe physical topology data may be conveniently acquired from the BMC in the startup process of the BIOS, thereby utilizing the PCIe physical topology data and the PCIe device logical information to obtain the PCIe system topology of the server. The PCIe device asset information of the server may be conveniently acquired, thereby facilitating display of the server configurations.

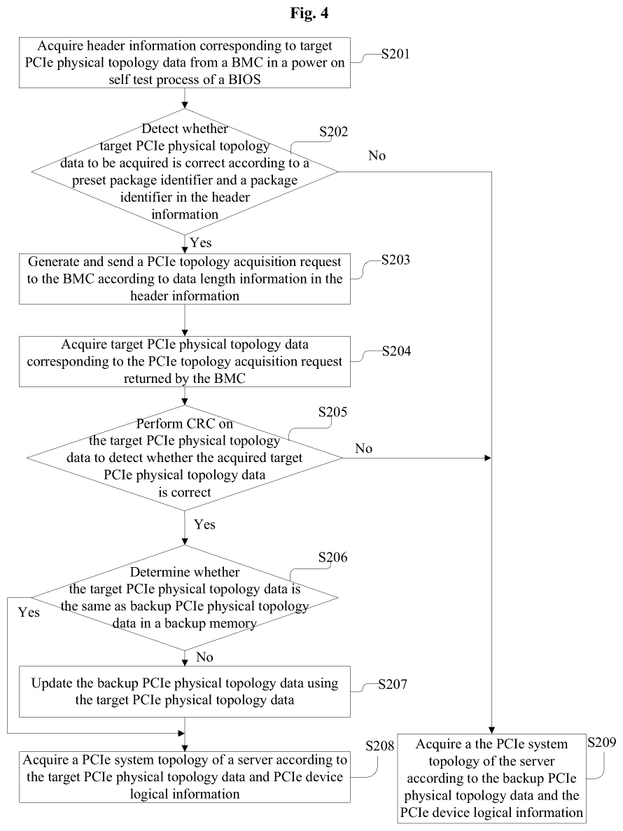

Referring to FIG. 4, FIG. 4 is a flowchart of another server asset information acquisition method according to an embodiment of the present disclosure. The asset information acquisition method may include the following operations 201 to 209.

In operation 201, header information corresponding to target PCIe physical topology data is acquired from a BMC in a power on self test process of a BIOS.

The target PCIe physical topology data is PCIe physical topology data corresponding to a target package, the target package is any one of one or more preset packages, and a preset memory stores PCIe physical topology data corresponding to each of the one or more preset packages.

It should be understood that in this embodiment, a processor running the BIOS on a server may acquire the header information corresponding to the target PCIe physical topology data in the preset memory from the powered-on BMC in the POST process of the BIOS startup. For example, the header information corresponding to the target PCIe physical topology data is acquired from the BMC through the ipmi, thereby utilizing the header information to detect whether a PCIe topology corresponding to the target PCIe physical topology data is a PCIe topology supported by the server, and avoiding transmission of incorrect PCIe physical topology data.

In some exemplary embodiments, in this operation, the processor may send a PCIe topology header acquisition request to the BMC in the power on self test process of the BIOS startup; and the header information corresponding to the target PCIe physical topology data returned by the BMC is received. Correspondingly, after receiving the PCIe topology header acquisition request, the BMC may utilize a preset package identifier to search for and acquire header information corresponding to PCIe physical topology data (i.e., the target PCIe physical topology data) corresponding to the preset package identifier from the preset memory (e.g., EEPROM), and the header information is sent to the server. For example, the header information and the preset package identifier may be sent to the server together.

In operation 202, whether target PCIe physical topology data to be acquired is correct is detected according to the preset package identifier and a package identifier in the header information; the flow proceeds to operation 203 when the target PCIe physical topology data to be acquired is correct; and the flow proceeds to operation 209 when the target PCIe physical topology data to be acquired is incorrect.

In this operation, the processor may determine whether the target PCIe physical topology data to be acquired is correct by comparing the preset package identifier with the package identifier in the header information, namely, whether the PCIe topology corresponding to the target PCIe physical topology data to be acquired is the PCIe topology supported by the server. Therefore, when the preset package identifier is the same as the package identifier in the header information, it is determined that the target PCIe physical topology data to be acquired is correct, and acquisition of the target PCIe physical topology data continues. When the preset package identifier is different from the package identifier in the header information, it is determined that the target PCIe physical topology data to be acquired is incorrect, and backup PCIe physical topology data stored in a backup memory may be utilized to acquire a PCIe system topology of the server to ensure normal startup of the BIOS.

In operation 203, a PCIe topology acquisition request is generated and sent to the BMC according to data length information in the header information.

In this operation, the processor may generate the PCIe topology acquisition request according to the data length information in the header information, thereby facilitating subsequent data lookup by the BMC.

In operation 204, target PCIe physical topology data corresponding to the PCIe topology acquisition request and returned by the BMC is acquired.

In operation 205, a cyclic redundancy check is performed on the target PCIe physical topology data to detect whether the acquired target PCIe physical topology data is correct; the flow proceeds to operation 206 when the acquired target PCIe physical topology data is correct; and the flow proceeds to operation 209 when the acquired target PCIe physical topology data is incorrect.

It should be understood that in this operation, by performing the Cyclic Redundancy Check (CRC) on the PCIe physical topology data, the processor detects whether the target PCIe physical topology data acquired from the BMC is correct, such that when the acquired target PCIe physical topology data is correct, operation 206 is performed, and when the acquired target PCIe physical topology data is incorrect, operation 209 is performed, and the backup PCIe physical topology data stored in the backup memory is utilized to acquire the PCIe system topology of the server, thereby ensuring normal startup of the BIOS.

For example, in this operation, the processor may detect whether the acquired target PCIe physical topology data is correct by performing CRC32 calculation on the target PCIe physical topology data, wherein when the acquired target PCIe physical topology data is correct, operation 206 is performed, and when the acquired target PCIe physical topology data is incorrect, operation 209 is performed.

In operation 206, whether the target PCIe physical topology data is the same as the backup PCIe physical topology data in the backup memory is determined; the flow proceeds to operation 207 when the target PCIe physical topology data is different from the backup PCIe physical topology data in the backup memory; and the flow proceeds to operation 208 when the target PCIe physical topology data is the same as the backup PCIe physical topology data in the backup memory.

It should be understood that in this operation, the processor determines whether to update the backup PCIe physical topology data in the backup memory by detecting whether the acquired correct PCIe physical topology data (i.e., the target PCIe physical topology data) is the same as the PCIe physical topology data (i.e., the backup PCIe physical topology data) in the backup memory (e.g., a backup EEPROM), thereby updating the backup PCIe physical topology data by performing operation 207 when the data is different.

In operation 207, the backup PCIe physical topology data is updated using the target PCIe physical topology data.

In operation 208, the PCIe system topology of the server is acquired according to the target PCIe physical topology data and the PCIe device logical information.

This operation is similar to operation 103, which is not repeated herein.

In operation 209, the PCIe system topology of the server is acquired according to the backup PCIe physical topology data and the PCIe device logical information.

It should be understood that in this operation, when the acquired or unacquired target PCIe physical topology data is incorrect, the processor may utilize the backup PCIe physical topology data in the backup memory to obtain the PCIe system topology of the server, thereby ensuring normal startup of the BIOS, such as normally filling in SMBIOS type9.

Correspondingly, this operation may also include an error reporting process to promptly inform the user of problems in the server. For example, when the preset package identifier is different from the package identifier in the header information, the processor may output a package error reporting message; and when the acquired target PCIe physical topology data is incorrect, a data error reporting message is outputted.

According to this embodiment of the present disclosure, whether the target PCIe physical topology data to be acquired is correct is detected according to the preset package identifier and the package identifier in the header information, to avoid acquisition and usage of incorrect PCIe physical topology data. By setting the backup PCIe physical topology data in the backup memory, normal startup of the BIOS may be ensured.

Corresponding to the above method embodiments, an embodiment of the present disclosure further provides a server asset information acquisition apparatus. The server asset information acquisition apparatus described below and the server asset information acquisition method described above may be cross-referenced correspondingly.

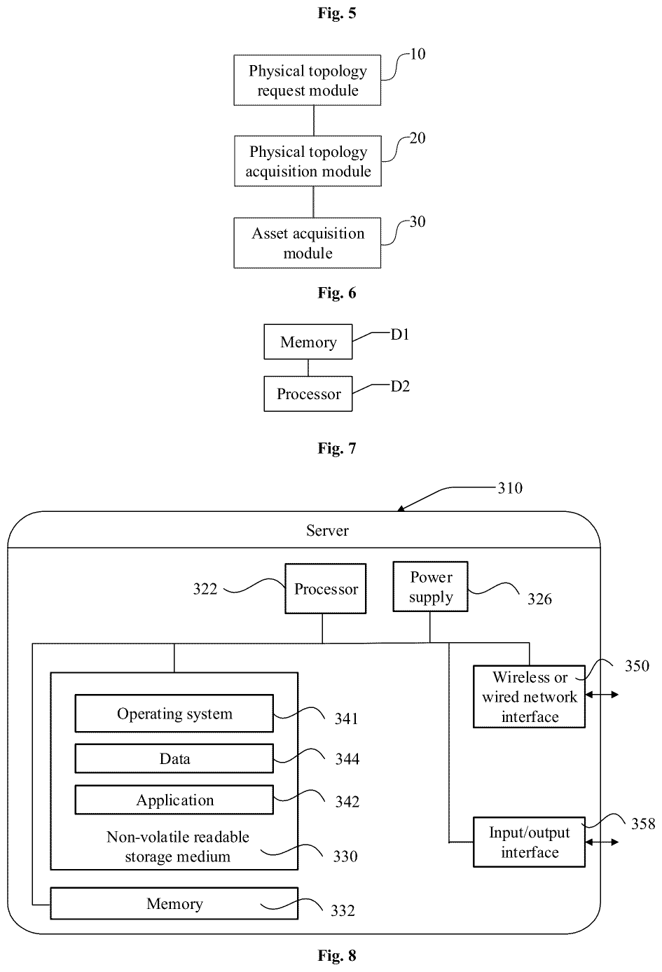

Referring to FIG. 5, FIG. 5 is a block diagram of a structure of a server asset information acquisition apparatus according to an embodiment of the present disclosure. The server asset information acquisition apparatus may include:
a physical topology request module 10, configured to send a high-speed serial computer expansion bus standard (PCIe) physical topology acquisition request to a baseboard management controller in a startup process;
a physical topology acquisition module 20, configured to acquire PCIe physical topology data corresponding to the PCIe topology acquisition request and returned by the baseboard management controller, wherein the PCIe physical topology data is stored in a preset memory accessible by the baseboard management controller; and
an asset acquisition module 30, configured to acquire a PCIe system topology of a server according to the PCIe physical topology data and PCIe device logical information.

In some exemplary embodiments, the PCIe physical topology data includes at least one of PCIe root port information, PCIe bandwidth information, a PCIe device type, and a PCIe device number. The PCIe device logical information includes at least one of a device type, a root port, and bus device function information corresponding to each PCI device.

In some exemplary embodiments, the physical topology acquisition module 20 may be configured to acquire target PCIe physical topology data corresponding to the PCIe topology acquisition request and returned by the baseboard management controller, wherein the target PCIe physical topology data is PCIe physical topology data corresponding to a target package, the target package is any one of one or more preset packages, and the preset memory stores PCIe physical topology data corresponding to each of the one or more preset packages.

In some exemplary embodiments, the server asset information acquisition apparatus may further include:
a header acquisition module, configured to acquire header information corresponding to the target PCIe physical topology data from the baseboard management controller;
a header detection module, configured to detect whether the target PCIe physical topology data to be acquired is correct according to a preset package identifier and a package identifier in the header information; and
a request generation module, configured to generate a PCIe topology acquisition request according to data length information in the header information and send a start signal to the physical topology request module 10 when the target PCIe physical topology data to be acquired is correct.

In some exemplary embodiments, the server asset information acquisition apparatus may further include:
a resource pushing module, configured to send the PCIe device logical information to the baseboard management controller, to enable the baseboard management controller to obtain a PCIe system topology of the server according to the PCIe physical topology data and the PCIe device logical information.

In some exemplary embodiments, the server asset information acquisition apparatus may further include:
a storage update module, configured to control, according to an acquired PCIe physical topology adjustment instruction, the baseboard management controller to update the PCIe physical topology data stored in the preset memory.

In some exemplary embodiments, the PCIe physical topology data includes PCIe root port information, and the PCIe root port information includes x2 port indexes corresponding to respective PCIe root ports of a Central Processing Unit (CPU).

In some exemplary embodiments, the PCIe physical topology data includes a PCIe device type and a PCIe device number. The PCIe device type includes: an “O” identifier corresponding to an open compute project card type, an “N” identifier corresponding to a non-volatile memory host controller interface specification device type, a “G” identifier corresponding to a graphics processing unit type, a “T” identifier corresponding to an adapter expansion card type, and/or a “P” identifier corresponding to other PCIe device types. The PCIe device number includes: 0 corresponding to the open compute project card type, a decimal label number corresponding to the non-volatile memory host controller interface specification device type, a decimal label number corresponding to the graphics processing unit type, a decimal label number corresponding to the adapter expansion card type, and/or a decimal label number corresponding to other PCIe device types.

In some exemplary embodiments, the server asset information acquisition apparatus may further include:
a backup determination module, configured to determine whether the PCIe physical topology data is the same as backup PCIe physical topology data in a backup memory; and send a start signal to the asset acquisition module 30 when the PCIe physical topology data is the same as the backup PCIe physical topology data in the backup memory; and
a backup update module, configured to update the backup PCIe physical topology data using the PCIe physical topology data and send a start signal to the asset acquisition module 30 when the PCIe physical topology data is different from the backup PCIe physical topology data in the backup memory.

In some exemplary embodiments, the server asset information acquisition apparatus may further include:
a data check module, configured to perform a cyclic redundancy check on the PCIe physical topology data, detect whether the acquired PCIe physical topology data is correct, and send a start signal to the backup determination module when the acquired target PCIe physical topology data is correct; and
a backup acquiring module 30, configured to acquire the PCIe system topology of the server according to the backup PCIe physical topology data and the PCIe device logical information when the acquired target PCIe physical topology data is incorrect.

According to this embodiment of the present disclosure, by storing the PCIe physical topology data in the preset memory accessible by the BMC of the server, the PCIe physical topology data may be conveniently acquired from the BMC in the startup process of the BIOS, thereby utilizing the PCIe physical topology data and the PCIe device logical information to obtain the PCIe system topology of the server through the asset acquisition module 30. The PCIe device asset information of the server may be conveniently acquired, thereby facilitating display of the server configurations.

Corresponding to the above method embodiments, an embodiment of the present disclosure further provides a server. The server described below and the server asset information acquisition method described above may be cross-referenced correspondingly.

Referring to FIG. 6, FIG. 6 is a schematic diagram of a structure of a server according to an embodiment of the present disclosure. The server may include:
a memory D1, configured to store a computer program; and
a processor D2, configured to implement, when executing the computer program, the operations of the server asset information providing method provided in the above method embodiment.

In some exemplary embodiments, referring to FIG. 7, FIG. 7 is a schematic diagram of an exemplary structure of a server according to an embodiment of the present disclosure. The server 310 may vary significantly due to different configurations or performance, and may include one or more Central Processing Units (CPUs) 322 (e.g., one or more processors) and a memory 332, as well as one or more non-volatile readable storage media 330 (e.g., one or more mass storage devices) that store applications 342 or data 344. The memory 332 and the non-volatile readable storage medium 330 may be used for transient storage or permanent storage. A program stored in the non-volatile readable storage medium 330 may include one or more modules (which are not marked in the figure), and each module may include a series of instruction operations for a data processing device. The central processing unit 322 may be configured to communicate with the non-volatile readable storage medium 330, and perform the series of instruction operations from the non-volatile readable storage medium 330 on the server 310.

The server 310 may further include one or more power supplies 326, one or more wired or wireless network interfaces 350, one or more input/output interfaces 358, and/or, one or more operating systems 341, such as Windows™ Server (Windows operating system), Mac OS X™ (Apple operating system), Unix™ (Unix operating system), Linux™ (Linux operating system), and Free Berkeley Software Distribution™ (FreeBSD™, an open-source Unix-like operating system).

The operations in the server asset information acquisition method described above may be implemented through the structure of the server.

Corresponding to the above method embodiments, an embodiment of the present disclosure further provides a server asset information providing method. The server asset information providing method described below and the server asset information acquisition method described above may be cross-referenced correspondingly.

Referring to FIG. 8, FIG. 8 is a flowchart of a server asset information providing method according to an embodiment of the present disclosure. The server asset information providing method may include the following operations 401 to 403.

In operation 401, a baseboard management controller acquires a PCIe physical topology acquisition request of a server.

It should be understood that in this operation, the Baseboard Management Controller (BMC) that is powered on to run may receive a PCIe physical topology acquisition request sent by a processor running a BIOS in the server, thereby searching for corresponding PCIe physical topology data from a preset memory according to the request.

Correspondingly, before this operation, the BMC may also send header information corresponding to the PCIe physical topology data to the server, such that the processor running the BIOS may utilize the header information to detect whether PCIe physical topology data to be acquired is correct. For example, after receiving a PCIe topology header acquisition request sent by the server, the BMC may utilize a preset package identifier to search for header information corresponding to PCIe physical topology data (i.e., target PCIe physical topology data) corresponding to the preset package identifier from the preset memory (e.g., EEPROM), and send the header information to the server. Correspondingly, the BMC may send the header information and the preset package identifier to the server together, thereby facilitating check by the server.

In operation 402, PCIe physical topology data is acquired from the preset memory according to the PCIe physical topology acquisition request.

It should be understood that in this operation, the BMC may search for and acquire the corresponding PCIe physical topology data from the preset memory according to the received PCIe physical topology acquisition request. For example, after receiving the PCIe physical topology acquisition request, the BMC may utilize the preset package identifier to acquire the target PCIe physical topology data from the preset memory, wherein the preset memory stores PCIe physical topology data corresponding to each of one or more preset packages, the target PCIe physical topology data is PCIe physical topology data corresponding to a target package, the target package is any one of the one or more preset packages, and the target package may be a preset package corresponding to the preset package identifier.

In some exemplary embodiments, the specific type of the preset memory and the specific content of the PCIe physical topology data stored in the preset memory may be correspondingly set with reference to the settings in the embodiment of the server asset information acquisition method described above. This embodiment does not impose any limitation on this.

In operation 403, the PCIe physical topology data is sent to the server to enable the server to acquire a PCIe system topology of the server according to the PCIe physical topology data and PCIe device logical information.

In some exemplary embodiments, in this operation, the BMC may send the PCIe physical topology data to the processor running the BIOS in the server, such that the server may obtain the PCIe system topology (namely actual PCIe device asset information) in the startup process of the BIOS, thereby providing the PCIe device asset information.

After operation 403, the server asset information providing method provided in this embodiment may further include the following operations: the BMC receives the PCIe device logical information sent by the server; and acquires the PCIe system topology of the server according to the PCIe physical topology data and the PCIe device logical information, thereby causing the BMC to obtain the PCIe device asset information actually configured in the server.

Correspondingly, in this embodiment, the BMC may also adjust a heat dissipation strategy according to the acquired PCIe system topology of the server, thereby ensuring that the heat dissipation strategy conforms to an actual configuration of the server.

In this embodiment, the BMC may also detect whether there is a missing PCIe device in the server according to the PCIe system topology and the PCIe physical topology data; when there is the missing PCIe device in the server, a PCIe device type and/or a PCIe device number corresponding to the missing PCIe device in the PCIe physical topology data are/is displayed. For example, the PCIe device type and the PCIe device number corresponding to the missing PCIe device are displayed on a web page, thereby facilitating the user in timely understanding of the situation of missing of the PCIe device configured in the server.

Correspondingly, when the PCIe device logical information includes bandwidth information corresponding to each PCIe device, in this embodiment, the BMC may also detect whether there is an incorrect bandwidth in the server according to the PCIe system topology and the PCIe physical topology data; and when there is the incorrect bandwidth in the server, bandwidth information (i.e., an actual bandwidth) in PCIe device logical information and PCIe bandwidth information (i.e., a configured bandwidth) in the PCIe physical topology data corresponding to the incorrect bandwidth are displayed.

In this embodiment, the BMC may also send the acquired PCIe system topology of the server to the web page for display, such that the user may view the PCIe system topology of the server on the web page through a remote terminal.

Correspondingly, in this embodiment, the BMC may also update the PCIe physical topology data stored in the preset memory according to a PCIe physical topology modification instruction sent by the server or the remote terminal. In other words, the BMC in the server may update the PCIe physical topology data stored in the preset memory according to the PCIe physical topology modification instruction sent by the processor in the server or the PCIe physical topology modification instruction sent by the remote terminal through a web page configuration, so as to flexibly update a PCIe topology for a new PCIe device, and avoid a re-adaptation action of the PCIe devices due to the addition of the new PCIe device.

According to this embodiment of the present disclosure, by storing the PCIe physical topology data in the preset memory accessible by the BMC of the server, the PCIe physical topology data may be conveniently acquired from the BMC in the startup process of the BIOS. By providing the PCIe physical topology data to the server, the server may utilize the PCIe physical topology data and the PCIe device logical information to acquire the PCIe system topology of the server in the startup process of the BIOS, thereby conveniently providing the PCIe device asset information of the server.

Corresponding to the above method embodiments, an embodiment of the present disclosure further provides a server asset information providing apparatus. The server asset information providing apparatus described below and the server asset information providing method described above may be cross-referenced correspondingly.

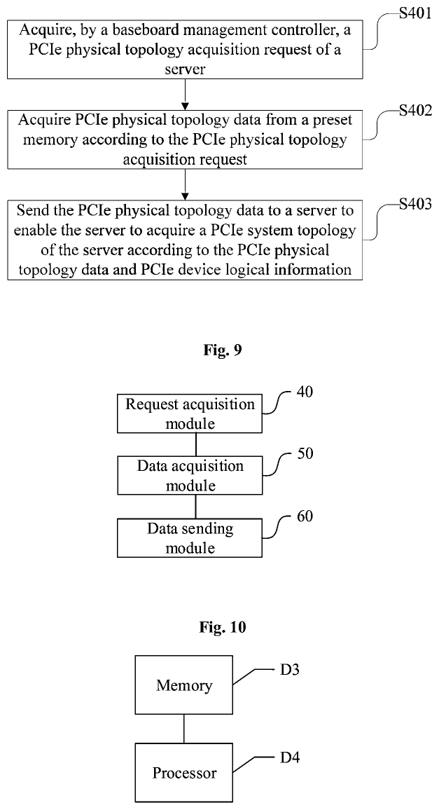

Referring to FIG. 9, FIG. 9 is a block diagram of a structure of a server asset information providing apparatus according to an embodiment of the present disclosure. The server asset information providing apparatus is applied to a BMC, and may include:
a request acquisition module 40, configured to acquire a high-speed serial computer expansion bus standard (PCIe) physical topology acquisition request of a server;
a data acquisition module 50, configured to acquire PCIe physical topology data from a preset memory according to the PCIe physical topology acquisition request; and
a data sending module 60, configured to send the PCIe physical topology data to the server to enable the server to acquire a PCIe system topology of the server according to the PCIe physical topology data and PCIe device logic information.

In some exemplary embodiments, the server asset information providing apparatus may further include:
a logical reception module, configured to receive the PCIe device logical information sent by the server; and
an asset generation module, configured to acquire the PCIe system topology of the server according to the PCIe physical topology data and the PCIe device logical information.

In some exemplary embodiments, the server asset information providing apparatus may further include:
an asset display module, configured to send the PCIe system topology to a web page for display.

In some exemplary embodiments, the server asset information providing apparatus may further include:
a missing detection module, configured to detect whether there is a missing PCIe device in the server according to the PCIe system topology and the PCIe physical topology data; and
a missing display module, configured to display a PCIe device type and/or a PCIe device number corresponding to the missing PCIe device in the PCIe physical topology data when there is the missing PCIe device.

In some exemplary embodiments, the server asset information providing apparatus may further include:
a storage update module, configured to update the PCIe physical topology data stored in the preset memory according to a PCIe physical topology modification instruction sent by the server or a remote terminal.

In this embodiment, according to this embodiment of the present disclosure, by storing the PCIe physical topology data in the preset memory accessible by the BMC of the server, the PCIe physical topology data may be conveniently acquired from the BMC in a startup process of a BIOS. By providing the PCIe physical topology data to the server through the data sending module 60, the server may utilize the PCIe physical topology data and the PCIe device logical information to acquire the PCIe system topology of the server in the startup process of the BIOS, thereby conveniently providing PCIe device asset information of the server.

Corresponding to the above method embodiments, an embodiment of the present disclosure further provides a baseboard management controller. The baseboard management controller described below and the server asset information providing method described above may be cross-referenced correspondingly.

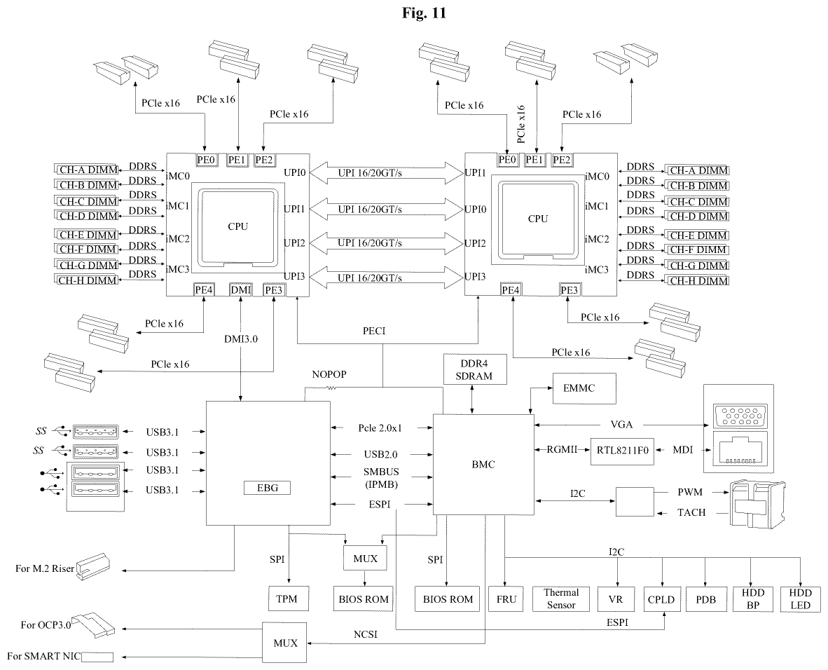

Referring to FIG. 10, FIG. 10 is a schematic diagram of a structure of a baseboard management controller according to an embodiment of the present disclosure. The BMC may include:
a memory D3, configured to store a computer program; and
a processor D4, configured to implement, when executing the computer program, the operations of the server asset information providing method provided in the above method embodiment.

Corresponding to the above method embodiments, an embodiment of the present disclosure further provides a computer non-volatile readable storage medium. The computer non-volatile readable storage medium described below and the server asset information acquisition method and the server asset information providing method described above may be cross-referenced correspondingly.

According to the computer non-volatile readable storage medium, the non-volatile readable storage medium stores a computer program, and the computer program, when executed by a processor, implements the operations of the server asset information acquisition method or the server asset information providing method provided in the above method embodiment.

The computer non-volatile readable storage medium may be various types of non-volatile readable storage media capable of storing program code, such as a U disk, a mobile hard drive, a Read-Only Memory (ROM), a Random Access Memory (RAM), a magnetic disk, or an optical disc.

FIG. 11 is a schematic diagram of a structure for implementing the server asset information acquisition method according to the embodiments of the present disclosure. With reference to FIG. 11, the hardware architecture for implementing the server asset information acquisition method will be described, and how the operations of the server asset information acquisition method are implemented based on this hardware architecture will also be provided as follows.

### Hardware Architecture Description (Taking FIG. 11 as an Example)

1. Central Processing Unit (CPU): The CPU is the core of the server, executing the computer program that implements the server asset information acquisition method. It interacts with other components to retrieve and process PCIe topology data.
2. Basic Input/Output System (BIOS): The BIOS is a firmware that initializes the server's hardware components during startup and is responsible for sending the PCIe physical topology acquisition request to the BMC.
3. Baseboard Management Controller (BMC): The BMC is a server management subsystem that interfaces with the BIOS. It is responsible for storing the PCIe physical topology data in its accessible preset memory (e.g., EEPROM) and retrieving this data upon request from the BIOS.
4. Preboot Execution Environment (PXE): Although not explicitly mentioned, PXE could be involved in the early stages of the BIOS startup process so assist in the procedure of network startup and related hardware configuration data retrieval.
5. Memory (RAM): The server's memory stores the operating system, application programs, and temporary data used during the execution of the asset information acquisition method.
6. Non-Volatile Read-Only Memory (ROM): This memory stores the BIOS firmware and possibly the backup PCIe physical topology data.
7. Hard Disk Drive (HDD) or Solid State Drive (SSD): Stores the computer programs and data, including the presets and logs of the PCIe physical topology.
8. Network Interface Card (NIC): Allows the server to communicate with the BMC and possibly other networked devices for asset information retrieval.
9. Input/Output Interfaces: Includes ports for connecting peripherals, which might be used to interact with external devices for asset management.
10. Power Supply Unit (PSU): Provides power to all components of the server.

Implementation of the Server Asset Information Acquisition Method on Hardware Architecture
1. BIOS Startup Process: Upon server startup, the BIOS initiates the process by sending a PCIe physical topology acquisition request to the BMC (\[Claim 1\]).
2. BMC Response: The BMC, which has access to the preset storage (EEPROM), retrieves the PCIe physical topology data corresponding to the PCIe physical topology acquisition request and sends the PCIe physical topology data back to the BIOS (\[Claim 1\]).
3. Data Processing: The CPU, with the assistance of the BIOS, processes the received PCIe physical topology data along with the PCIe device logical information to construct the server's PCIe system topology (\ [Claim 1\], [Claim 2\]).
4. Logical Information Acquisition: The server's processor detects and gathers logical information about the actual configuration of PCIe devices during the BIOS startup process (\[Claim 2\]).
5. System Topology Generation: Using the physical topology data and the PCIe device logical information, the server generates its PCIe system topology, which is crucial for understanding the server's configuration and asset management (\ [Claim 1\]).
6. Error Handling and Data Verification: If the acquired PCIe physical topology data is incorrect or does not match the backup data in ROM, the system utilizes the backup data to ensure the continuity of the BIOS startup process (\ [Claim 9\], [Claim 10\]).
7. Data Update and Storage: If new PCIe physical topology data is received and is different from the backup, the system updates the backup data stored in ROM to maintain an accurate record of the server's configuration (\ [Claim 9\]).
8. Interface for Further Actions: The generated PCIe system topology can be used for further actions such as adjusting cooling strategies, detecting missing PCIe devices, and updating web page displays, which might involve interaction with the NIC and other I/O interfaces (\ [Claim 11\], [Claim 15\], [Claim 16\]).

This method leverages the hardware components of the server to efficiently manage and retrieve asset information related to PCIe devices, ensuring that the server's configuration is accurately represented and can be easily accessed for management purposes. The actual implementation may vary depending on the specific hardware configuration and the details of the hardware structure, which are not elaborated in the text.

The various embodiments in the specification are described in a progressive manner, highlighting the differences between each embodiment and other embodiments. The identical or similar parts between different embodiments may be cross-referenced to each other. Since the apparatuses, the server, the baseboard management controller, and the computer non-volatile readable storage medium disclosed in the embodiments correspond to the methods disclosed in the embodiments, the description is simple, and for related parts, reference is made to part of descriptions of the method.

The server asset information acquisition method and apparatus, the server asset information providing method and apparatus, the baseboard management controller, and the server provided in the embodiments of the present disclosure are introduced in detail as above. The exemplary implementations are applied in this specification to illustrate the principles and implementations of the present disclosure. The descriptions of the above embodiments are only configured to facilitate understanding of the methods and core ideas of the present disclosure. It should be noted that those having ordinary skill in the art may also make a plurality of improvements and modifications on the present disclosure without departing from the principle of the present disclosure, and these improvements and modifications shall fall within the scope of protection of the present disclosure.

What is claimed is:

1. A server asset information acquisition method, comprising:
sending a high-speed serial computer expansion bus standard (PCIe) physical topology acquisition request to a baseboard management controller in a startup process of a basic input output system;
acquiring PCIe physical topology data corresponding to the PCIe topology acquisition request and returned by the baseboard management controller, wherein the PCIe physical topology data is stored in a preset memory accessible by the baseboard management controller; and
acquiring a PCIe system topology of a server according to the PCIe physical topology data and PCIe device logical information.

2. The server asset information acquisition method according to claim 1, wherein the PCIe physical topology data comprises at least one of PCIe root port information, PCIe bandwidth information, a PCIe device type, and a PCIe device number; and the PCIe device logical information comprises at least one of a device type, a root port, and bus device function information corresponding to each PCI device.

3. The server asset information acquisition method according to claim 1, wherein the acquiring PCIe physical topology data corresponding to the PCIe topology acquisition request and returned by the baseboard management controller comprises:
acquiring target PCIe physical topology data corresponding to the PCIe topology acquisition request and returned by the baseboard management controller, wherein the target PCIe physical topology data is PCIe physical topology data corresponding to a target package, the target package is any one of one or more preset packages, and the preset memory stores PCIe physical topology data corresponding to each of the one or more preset packages.

4. The server asset information acquisition method according to claim 3, wherein before the sending a PCIe topology acquisition request to a baseboard management controller, the server asset information acquisition method further comprises:
acquiring header information corresponding to the target PCIe physical topology data from the baseboard management controller;
detecting whether the target PCIe physical topology data to be acquired is correct according to a preset package identifier and a package identifier in the header information; and
when the target PCIe physical topology data to be acquired is correct, generating the PCIe topology acquisition request according to data length information in the header information, and sending the PCIe topology acquisition request to the baseboard management controller.

5. The server asset information acquisition method according to claim 1, wherein after the acquiring a PCIe system topology of a server according to the PCIe physical topology data and PCIe device logical information, the server asset information acquisition method further comprises:
sending the PCIe device logical information to the baseboard management controller, to enable the baseboard management controller to obtain the PCIe system topology of the server according to the PCIe physical topology data and the PCIe device logical information.

6. The server asset information acquisition method according to claim 1, further comprising:
controlling, according to an acquired PCIe physical topology adjustment instruction, the baseboard management controller to update the PCIe physical topology data stored in the preset memory.

7. The server asset information acquisition method according to claim 2, wherein the PCIe physical topology data comprises the PCIe root port information, and the PCIe root port information comprises x2 port indexes corresponding to respective PCIe root ports of a Central Processing Unit (CPU).

8. The server asset information acquisition method according to claim 2, wherein the PCIe physical topology data comprises a PCIe device type and a PCIe device number; the PCIe device type comprises: an “O” identifier corresponding to an open compute project card type, an “N” identifier corresponding to a non-volatile memory host controller interface specification device type, a “G” identifier corresponding to a graphics processing unit type, a “T” identifier corresponding to an adapter expansion card type, and/or a “P” identifier corresponding to other PCIe device types; and the PCIe device number comprises: 0 corresponding to the open compute project card type, a decimal label number corresponding to the non-volatile memory host controller interface specification device type, a decimal label number corresponding to the graphics processing unit type, a decimal label number corresponding to the adapter expansion card type, and/or a decimal label number corresponding to other PCIe device types.

9. The server asset information acquisition method according to claim 1, wherein after the acquiring PCIe physical topology data corresponding to the PCIe topology acquisition request and returned by the baseboard management controller, the server asset information acquisition method further comprises:
determining whether the PCIe physical topology data is the same as backup PCIe physical topology data in a backup memory;
when the PCIe physical topology data is the same as the backup PCIe physical topology data in the backup memory, acquiring the PCIe system topology of the server according to the PCIe physical topology data and the PCIe device logical information; and
when the PCIe physical topology data is different from the backup PCIe physical topology data in the backup memory, updating the backup PCIe physical topology data using the PCIe physical topology data, and acquiring the PCIe system topology of the server according to the PCIe physical topology data and the PCIe device logical information.

10. The server asset information acquisition method according to claim 9, wherein before the determining whether the PCIe physical topology data is the same as backup PCIe physical topology data in a backup memory, the server asset information acquisition method further comprises:
performing a cyclic redundancy check on the PCIe physical topology data to detect whether the acquired PCIe physical topology data is correct;
when the acquired target PCIe physical topology data is correct, determining whether the PCIe physical topology data is the same as the backup PCIe physical topology data in the backup memory; and
when the acquired target PCIe physical topology data is incorrect, acquiring the PCIe system topology of the server according to the backup PCIe physical topology data and the PCIe device logical information.

11. The server asset information acquisition method according to claim 1, further comprising:
utilizing the PCIe system topology actually configured in the server for subsequent processing comprising at least one of: web page display, heat dissipation strategy adjustment, and PCIe physical topology data check.

12. A server, comprising:
a memory, configured to store a computer program; and
a processor, configured to implement, when executing the computer program, operations comprising:
sending a high-speed serial computer expansion bus standard (PCIe) physical topology acquisition request to a baseboard management controller in a startup process of a basic input output system;
acquiring PCIe physical topology data corresponding to the PCIe topology acquisition request and returned by the baseboard management controller, wherein the PCIe physical topology data is stored in a preset memory accessible by the baseboard management controller; and
acquiring a PCIe system topology of a server according to the PCIe physical topology data and PCIe device logical information.

13. A server asset information providing method, comprising:
acquiring, by a baseboard management controller, a high-speed serial computer expansion bus standard (PCIe) physical topology acquisition request of a server,
acquiring PCIe physical topology data from a preset memory according to the PCIe physical topology acquisition request; and
sending the PCIe physical topology data to the server to enable the server to acquire a PCIe system topology of the server according to the PCIe physical topology data and PCIe device logical information.

14. The server asset information providing method according to claim 13, wherein after the sending the PCIe physical topology data to the server, the server asset information providing method further comprises:
receiving the PCIe device logical information sent by the server; and
acquiring the PCIe system topology of the server according to the PCIe physical topology data and the PCIe device logical information.

15. The server asset information providing method according to claim 14, wherein after the acquiring the PCIe system topology of the server according to the PCIe physical topology data and the PCIe device logical information, the server asset information providing method further comprises:
sending the PCIe system topology to a web page for display.

16. The server asset information providing method according to claim 14, wherein after the acquiring the PCIe system topology of the server according to the PCIe physical topology data and the PCIe device logical information, the server asset information providing method further comprises:
detecting whether there is a missing PCIe device in the server according to the PCIe system topology and the PCIe physical topology data; and
when there is the missing PCIe device in the server, displaying a PCIe device type and/or a PCIe device number corresponding to the missing PCIe device in the PCIe physical topology data.

17. The server asset information providing method according to claim 13, further comprising:
updating the PCIe physical topology data stored in the preset memory according to a PCIe physical topology modification instruction sent by the server or a remote terminal.

18. A baseboard management controller, comprising:
a memory, configured to store a computer program; and
a processor, configured to implement, when executing the computer program, the operations of the server asset information providing method according to claim 13.

19. A non-transitory computer non-volatile readable storage medium, wherein the computer non-volatile readable storage medium stores a computer program, and the computer program, when executed by a processor, implements the operations of the server asset information acquisition method according to claim 1.

20. A non-transitory computer non-volatile readable storage medium, wherein the computer non-volatile readable storage medium stores a computer program, and the computer program, when executed by a processor, implements the operations of the server asset information providing method according to claim 13.
